(19) United States
(12) Patent Application Publication
(10) Pub. No.: US 2010/0228785 A1
(43) Pub. Date: Sep. 9, 2010

(54) Row Column Storage

(76) Inventors: Blaine D. Gaither, Fort Collin, CO (US); F. Steven Chalmers, Roseville, CA (US); Greg Thelen, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/398,217

(22) Filed: Mar. 5, 2009

(51) Int. Cl. G06F 17/30; G06F 12/00

(52) U.S. Cl. 707/802; 711/E12.078; 707/E17.044; 707/803

(57) ABSTRACT

A method for accessing data is disclosed. The method comprises writing data for a multi-dimensional array to a physical storage device. The data is written to a physical storage device as two different linear strings. The first linear string contains the data from the multi-dimensional array in row format and the second linear string contains the data from the multi-dimensional array in column format.

### BACKGROUND

Computer databases use and store large amounts of information. The information used in databases is typically contained in tables. The tables in a database are typically organized into rows and columns of information. The tables in a database are typically stored into memory in one of two formats. The two formats are: row storage or column storage.

Both the row and column storage formats store the data as a linear string or linear list of data, the only difference is the order in which the data is stored. Row storage stores the data from each row in sequence, with the last entry of one row followed by the first entry in the next row. Column storage stores the data from each column in sequence, with the last entry of one column followed by the first entry in the next column. In one simple example, a database may contain the following table of date.

| Employee # | First Name | Last Name | Salary |
|---|---|---|---|
| 1 | John | Smith | 40,000 |
| 2 | Patty | Jones | 50,000 |
| 3 | Larry | Berg | 35,000 |

This simple table includes a column for the employee number, a column for the first and last name of the employee, and a column for the salary of the employee. Using a row format to store the data would result in the following linear string [I, John, Smith, 40,000, 2, Patty, Jones, 50,000, 3, Larry, Berg, 35,000]. Using a column format to store the data would result in the following linear string [1, 2, 3, John, Patty, Larry, Smith, Jones, Berg, 40,000, 50,000, 35,000].

When a database accesses (stores or retrieves) a row of data from a table, the access will be more efficient when the data is stored in row format. When a database accesses a column of data from a table, the access will be more efficient when the table is stored in column format.

### BRIEF DESCRIPTION OF THE DRAWINGS

FIG. 1 is a computer system 100 in an example embodiment of the invention.

FIG. 2a is a flow chart that shows the method for storing data to a physical device in one example embodiment of the invention.

FIG. 2b is a flow chart that shows the method for reading data from a physical device in one example embodiment of the invention.

### DETAILED DESCRIPTION

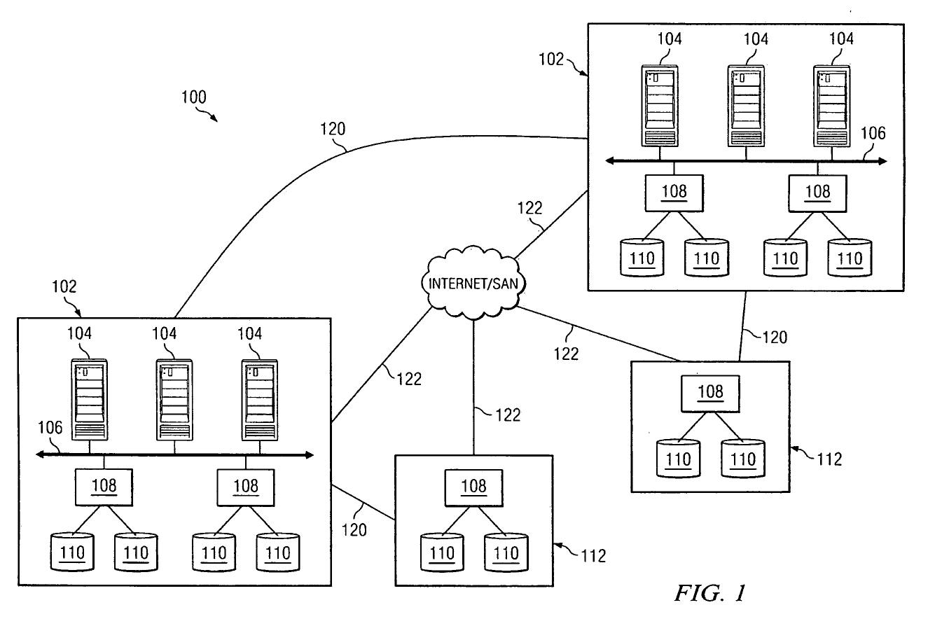

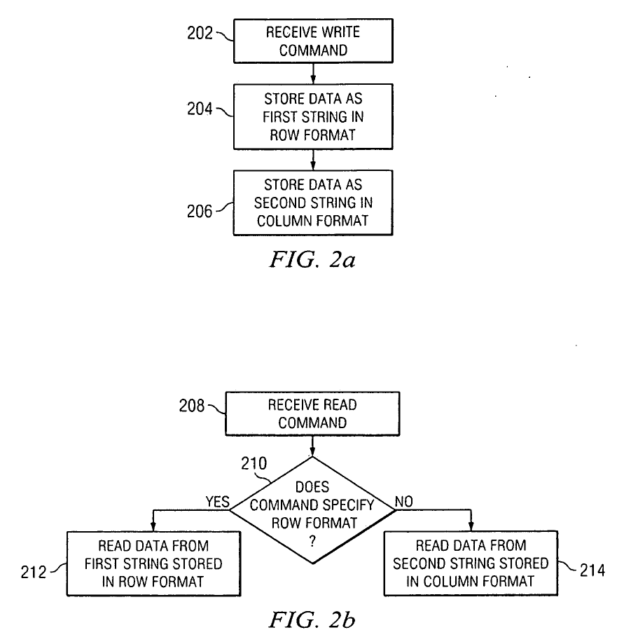

FIGS. 1-2, and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Databases are software applications that run on computer systems. Some databases only contain a small amount of data and may run on a single computer, for example a personal computer (PC). Many databases contain large amounts of data and are run in one or more data centers. Both large and small databases typically store the data contained in the database onto permanent or non-volatile storage devices. Permanent or non-volatile storage devices are devices that retain a copy of the data even with no power to the device. Examples of non-volatile storage devices include hard disk drives, optical drives, magneto-optical drives, tape drives, non-volatile random access memory (NVRAM), and the like.

FIG. 1 is a computer system 100 in an example embodiment of the invention. Computer system 100 comprises one or more data centers 102. Each data center 102 may contain one or more processors 104, an interlinking bus or fabric 106, one or more storage controllers 108, and one or more non-volatile storage devices 110. Processors 104 may comprise one or more central processing units (CPU's), one or more servers, micro-computers, blades, super computers, or the like. Processors 104 may also comprise random assess memory (RAM), cache memory, and the like. Processors 104 and storage controllers 108 are coupled together through the interlinking bus or fabric 106. Interlinking bus or fabric 106 may be any type of link used to couple two or more devices together, for example a parallel bus, point-to-point links, optical links, or the like.

Each storage controller 108 is coupled to one or more non-volatile storage devices 110. Non-volatile storage devices 110 may include hard disk drives, optical drives, magneto-optical drives, tape drives, non-volatile random access memory (NVRAM), and the like. Each storage controller 108 may have storage controller software running on the storage controller 108. The storage controller software may be configured to control the storage of data to the physical devices attached to the storage controller 108. In another example embodiment of the invention, storage controllers 108 may be implemented as software running on a server, or as a combination of an input/output (I/O) card and software.

Computer system 100 may also comprise one or more remote storage facilities 112. Remote storage facility 112 may comprise one or more memory controllers 108, and one or more non-volatile storage devices 110. Data centers 102 may be coupled to each other and to one or more remote storage facility 112. Data centers 102 may be coupled together with direct links 120 or coupled together with indirect links 122 through the internet or a Storage Area Network (SAN). Data centers 102 may be coupled to the remote storage facilities using a direct link 120 or using an indirect links 122 through the internet. The data centers 102 may be co-located or one data center may be located remotely from the other data center 102.

Computer system 100 may have one or more database programs executing in data centers 102. Databases are application programs that typically run on top of an operating system. Data centers 102 may have one or more operating systems running, where each instance of an operating system may be running on one or more processors 104. When a database is running, the database may access data. In this application, accessing data means that the database may either be reading stored data and/or storing data. The data will be read from or stored to a physical device. The physical device may be a volatile or a non-volatile device. The physical device may be RAM on the processors, a non-volatile storage device 110 in the data center 102, or may be the RAM or non-volatile storage devices 110 at a remote storage facility 112.

When an application program, like a database, accesses data, the data access typically goes through a chain of commands that results in a data access to a physical device. The application program typically makes a call to access the data from the operating system. The operating system may in turn make a data access call to a device driver or to a memory controller. The device driver or memory controller may respond to the data access request by accessing a physical device to read or write the data. The physical device accessed by the memory controller or device driver may be RAM, for example a cache, or may be a non-volatile storage device 110. Once the device driver or memory controller has read or written the data to/from the physical device, the results are passed back up through the operating system to the application program. In some cases, application programs may be configured to directly access a device driver or a memory controller.

Application programs may view data as a multi-dimensional array, for example a table. Physical devices, for example volatile and non-volatile storage devices, typically view data as a one dimensional linear string or list. When data from an application program is stored onto a physical device, any multi-dimensional arrays are typically transformed into a linear string or list before being stored. The data in the multi-dimensional array or table may be converted into the linear string using a column format or a row format.

The choice between converting the data in a table into either row or column format may be determined by how the table is defined in the program, by the compiler, by the format of the memory access call from the application program to the operating system, or by the format of the memory access call from the operating system to a memory controller or a device driver. Typically once this choice is made, the data from the table can only be accessed from the physical device using the format determined. For example, when a table has been created and saved onto a physical device as a linear list in row format, the table can only be efficiently accessed from the physical device in row format.

In one example embodiment of the invention, anytime a table is stored onto a physical device as a linear list using row or column format, an additional copy of the table will be created on a physical device as a linear list in the other format. In this way there will be two copies of any tables stored to a physical device, one copy in row format and one copy in column format. Writing the second copy of data to a physical device may occur at essentially the same time as the first copy is stored, or after some delay. When access to the table is required in row format, the table stored onto the physical device in row format is accessed. When access to the table is required in column format, the table stored onto the physical device in column format is accessed. Any time data is written to a table, both copies of the tables saved on the physical devices will be automatically updated.

In another example embodiment of the invention, only selected tables may have both a row and column linear string created and saved to the physical devices. When using a default memory access command, a table will be stored to a physical device using only one of the two formats. When using a special memory access command, two copies of the table, one in row format and one in column format, will be stored to a physical device. There may be a special row/column table creation command, a special row/column write command, a special row/column read command, or some combination of these commands. Only tables created or accessed using the special row/column commands would be saved onto a physical device as two different linear strings. Converting the multi-dimensional array or table into a linear list requires knowledge of the table dimensions. The table dimensions may be included in the special commands or may be stored separately with other program or memory information and accessed when converting the table into the linear string.

The transformation from the multi-dimensional data array to the linear string may occur at a number of different locations in the chain of commands that result in a data access to a physical device. The transformation may occur in the application program, in the operating system, in the memory manager (108), or in a device driver.

FIG. 2 is a flow chart for a method of accessing data in a computer system in an example embodiment of the invention. FIG. 2a is a flow chart that shows the method for storing data to a physical device in one example embodiment of the invention. FIG. 2b is a flow chart that shows the method for reading data from the physical device in one example embodiment of the invention. At step 202 in FIG. 2a, a write data command is received. At step 204 the data is written onto a physical device in a first linear string in row format. At step 206, the data is written onto a physical device in a second linear string in column format. Steps 204 and 206 may occur at the same time, or may occur at different times. At step 208 in FIG. 2b, a read command is received. At step 212 when the read command is in row format, the data is read from a first string stored on a physical device in row format. At step 214 when the read command is not in row format, the data is read from a second string stored on a physical device in column format.

In another example embodiment of the invention, the data in both the row and column format may be accessed using either a row or column access. For example the data stored on the device in row format may be accessed using a row format or accessed using a column format. To access the data, the device is addressed as a random accesses memory. The data is stored in storage elements which map to sectors, words, bytes or data in the media. The storage elements may be very short or of variable size. Commands are provided to allocate or de-allocate an n-dimensional matrix of storage elements on the device. These commands specify the number of rows or columns in the matrix as well as the number of the elements. Commands are provided for reading and writing entire rows or columns, or partial rows and columns or individual elements. Data is sent to and from the storage device in a sequential stream in row or column format. The device may include a controller with mapping tables between a linear address space seen outside the device and a physical address space inside the device. In one example embodiment, the media would be flash or battery-backed up ram.

What is claimed is:

1. A method for accessing data in a computer system, comprising:
receiving a write command for data contained in a multi-dimensional array wherein the multi-dimensional array has at least two dimensions;
storing a first linear string to a first physical device wherein the first linear string contains the data from the multi-dimensional array converted into the first linear string in row format; and
storing a second linear string to a second physical device wherein the second linear string contains the data from the multi-dimensional array converted into the second linear string in column format.

2. The method for accessing data in a computer system of claim 1, wherein the first and second physical devices are the same physical device.

3. The method for accessing data in a computer system of claim 1, wherein the write command is received by a computer program executing on the computer system and selected from the group comprising: an operating system, a storage controller program, a device driver.

4. The method for accessing data in a computer system of claim 1, wherein the write command includes the dimensions of the multi-dimensional array.

5. The method for accessing data in a computer system of claim 1, further comprising:
a database program, wherein the database program contains a table having the dimensions of the multi-dimensional array and wherein the database program sent the write command for data contained in the table.

6. The method for accessing data in a computer system of claim 1, wherein the write command is a special row/column write command.

7. The method for accessing data in a computer system of claim 1, wherein the write command is for data in only a subset of the multi-dimensional array.

8. A method for accessing data in a computer system, comprising:
receiving a read command for data;
when the read command specifies a row access, reading the data from a first physical device, wherein the data is stored on the first physical device as a first linear string in row format;
when the read command specifies column access, reading the data from a second physical device, wherein the data is stored on the second physical device as a second linear string in column format.

9. The method for accessing data in a computer system of claim 8, wherein the first and second physical devices are the same physical device.

10. The method for accessing data in a computer system of claim 8, wherein when the read command specifies the row access, the read command is for a subset of the data stored in the first linear string, and when the read command specifies the column access, the read command is for a subset of the data stored in the second linear string.

11. The method for accessing data in a computer system of claim 8, wherein when the read command specifies the row access, the first linear string is accessed using a column access.

12. A computer program executing on a computer system having at least one processor, comprising:
a write data command for data contained in a multi-dimensional array having at least two dimensions, wherein the write data command stores the data onto a physical device in a first linear string and a second linear string, wherein the first linear string contains the data in row format and the second linear string contains the data in column format.

13. The computer program executing on a computer system having at least one processor of claims 12, further comprising:
a read data command;
when the read data command specifies row access, reading the data contained in the first linear string stored on the physical device;
when the read data command specifies column access, reading the data contained in the second linear string stored on the physical device.

14. The computer program executing on a computer system having at least one processor of claims 12, wherein the computer program is selected from the group comprising: an operating system, an application program, memory controller software, a device driver.

15. A data center, comprising:
at least one processor;
at least one memory controller wherein the memory controller is coupled to the at least one processor, the memory controller also coupled to at least one non-volatile storage device and configured to store data from the processor onto the at least one non-volatile storage device;
at least one operating system running on the at least one processor, the at least one operating system controlling the execution of an application program running on the at least one processor;
the application program containing data organized as a table, the application program executing a command to store the table to the at least one non-volatile storage device wherein command causes the data from the table to be saved to the at least one non-volatile storage device as a first linear string in row format and a second linear string in column format.
